(19) United States
(12) Patent Application Publication
(10) Pub. No.: US 2010/0088327 A1
(43) Pub. Date: Apr. 8, 2010

(54) Method, Apparatus, and Computer Program Product for Identifying Media Item Similarities

(75) Inventors: Jukka Antero Holm, Tampere (FI); Antti Eronen, Tampere (FI); Arto Juhani Lehtiniemi, Lempaala (FI)

Correspondence Address: DITTHAVONG MORI & STEINER, P.C., 918 Prince Street, Alexandria, VA, 22314, US

(73) Assignee: Nokia Corporation

(21) Appl. No.: 12/244,369

(22) Filed: Oct. 2, 2008

(51) Int. Cl. G06F 17/30

(52) U.S. Cl. 707/758; 707/E17.009

(57) ABSTRACT

An apparatus for identifying media item similarities may include a processor. The processor may be configured to receive a modified playlist. The modified playlist may include representations of original playlist media items and a representation of a target media item. The modification to the playlist may involve the introduction of the representation of the target media item to the playlist. The processor may also be configured to modify a recommendation engine based on feedback generated in response to the target media item having been played as part of the modified playlist. Associated methods and computer program products may also be provided.

### TECHNICAL FIELD

Embodiments of the present invention relate generally to relationships between data, such as data in the form of media content, and, more particularly, relate to a method, apparatus, and a computer program product for collecting and analyzing perceived commonalities between media content.

### BACKGROUND

The days of music being sold on albums, tapes, and compact discs (CDs), in music stores of a shopping mall are quickly becoming a thing of the past. Increasingly, many consumers purchase their music and other media items from websites and other online sources. Upon purchasing the media items, consumers are able to download the music onto their computers, portable media players, or the like for playback.

Due in part to the reduced overhead associated with making media items available for purchase through online sources, a wide variety of music has been made available to consumers. Some of the music and media may not have been available at the music stores of the past. Additionally, through websites and other online sources, newly released media items can be made available to consumers for immediate download and enjoyment. As result, consumers are able locate a wider variety of preferable media items and, as such, consumers can be more selective with respect to the media items they purchase and download.

Further, due to the flexibility of media items stored as data files, consumers can now organize downloaded media items, and media items acquired through other means, based on the consumer's personal preference. For instance, music no longer must be organized based on an artist's release or limited by a static compilation of media items such as provided on a on a CD or album. Instead, consumers may organize media items in any manner they choose. In this regard, a set of file-based media items organized into a group is often referred to as a playlist.

Typically, a playlist amounts to a collection of representations or links to selected media items stored on a computer, portable media player, or the like. In this regard, consumers often generate playlists of, for example, music or movies having a similar genre, time period, theme, or other characteristic. In this regard, consumers often identify common characteristics between different media items based on the consumer's perception of the media items. Based on these common characteristics the individuals are able to classify media items into common categories and playlists.

### BRIEF SUMMARY

A method, apparatus, and computer program product are described that identify and collect information regarding similarities between media items, such as audio items (e.g., music tracks, audio books), video items (e.g., video clips, movies, photos), or the like for use by a recommendation engine. In this regard, exemplary embodiments of the present invention may provide for a target media item to be introduced into a playlist that was previously defined. The playlist may have been defined to include media items having a common theme, topic, category, etc. Exemplary embodiments may allow for a user to play the target media item within the playlist. In this regard, the target media item may have been introduced to the playlist unbeknownst to the user. In response to having played the media, embodiments of the present invention may identify feedback from the user regarding the similarity of the target media item to the original media items that were included in the playlist. Based on the feedback, embodiments of the present invention may provide for a media item recommendation engine to be modified.

Accordingly, in one exemplary embodiment, a method for identifying media item similarities is described. The method may include receiving a modified playlist. In this regard, the modified playlist may include representations of original playlist media items and a representation of a target media item. The modification to the playlist may have occurred as a result of the introduction of the representation of the target media item to the playlist. The method may also include modifying a recommendation engine based on feedback generated in response to the target media item having been played as part of the modified playlist on a media player device.

In another exemplary embodiment, an apparatus for identifying media item similarities is described. The apparatus may include a processor that may be configured to receive a modified playlist. In this regard, the modified playlist may include representations of original playlist media items and a representation of a target media item. The modification to the playlist may have occured as a result of the introduction of the representation of the target media item to the playlist. The processor may also be configured to modify a recommendation engine based on feedback generated in response to the target media item having been played as part of the modified playlist.

In another exemplary embodiment, a computer program product for identifying media item similarities is described. The computer program product may include at least one computer-readable storage medium having computer-readable program code instructions stored therein. The computer-readable program code instructions may include first program code instructions, and second program code instructions. The first program code instructions may be configured to receive a modified playlist. In this regard, the modified playlist may include representations of original playlist media items and a representation of a target media item. The modification to the playlist may have occurred as a result of the introduction of the representation of the target media item to the playlist. The second program code instructions may be configured to modify a recommendation engine based on feedback generated in response to the target media item having been played as part of the modified playlist.

In yet another exemplary embodiment, an apparatus for identifying media item similarities is described. The apparatus may include means for receiving a modified playlist. In this regard, the modified playlist may include representations of original playlist media items and a representation of a target media item. The modification to the playlist may have occurred as a result of the introduction of the representation of the target media item to the playlist. The apparatus may also include means for modifying a recommendation engine based on feedback generated in response to the target media item having been played as part of the modified playlist on a media player device.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a conceptual information flow for media item similarity data according to various exemplary embodiments of the present invention;

FIG. 2 illustrates a communications system and associated network entities that may interact to perform operations in accordance with various exemplary embodiments of the present invention;

FIG. 3 illustrates a block diagram of a service apparatus for identifying media item similarity data according to various exemplary embodiments of the present invention;

FIG. 4 illustrates a block diagram of a user platform apparatus for identifying media item similarity data according to various exemplary embodiments of the present invention;

FIG. 5 is a flowchart of an exemplary method for identifying media item similarity data according to various exemplary embodiments of the present invention;

FIG. 6 is a flowchart according to exemplary methods for identifying media item similarity data according to various exemplary embodiments of the present invention; and

FIG. 7 is a schematic block diagram of a system according to an example embodiment of the present invention.

### DETAILED DESCRIPTION

Embodiments of the present invention will now be described more fully hereinafter with reference to the accompanying drawings, in which some, but not all embodiments of the invention are shown. Indeed, the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received, operated on, and/or stored in accordance with embodiments of the present invention. Moreover, the term “exemplary,” as used herein, is not provided to convey any qualitative assessment, but instead to merely convey an illustration of an example. The term “media item,” as used herein, may refer to an audio, video or other media item including, but not limited to, a music track, a song, an album, an audio book, a radio program, a podcast, a video clip, a movie, a television program, a website, or a blog. A “playlist,” as used herein, may refer to any defined set of representations or links to a collection of media items. As used herein, “playing” a media item may refer to implementing the media item in manner that would allow user to experience the media item (e.g., playing a song, displaying a photo, displaying a website).

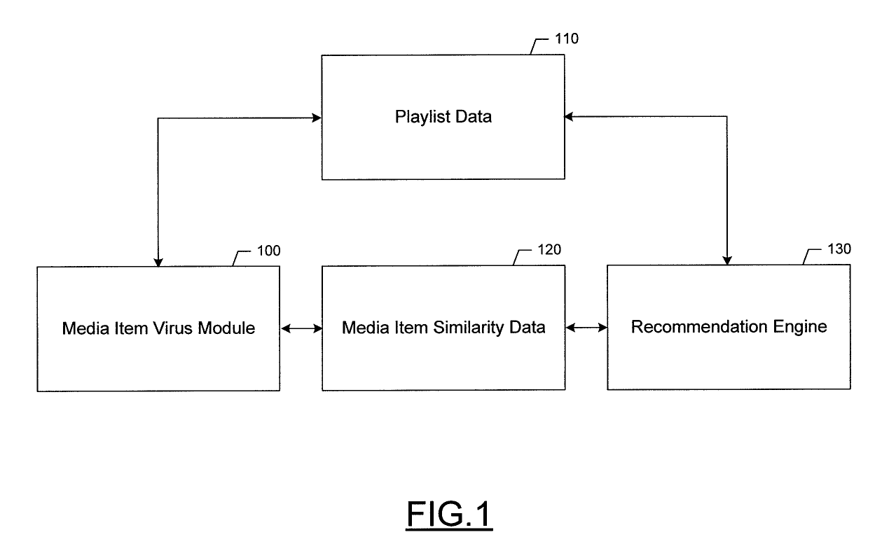

FIG. 1 is a schematic block diagram of a conceptual information flow system for media item similarity data according to various exemplary embodiments of the present invention. The information flow system of FIG. 1 includes a media item virus module 100, playlist data 110, media item similarity data 120, and a recommendation engine 130. The information flow system of FIG. 1 may be implemented in combination with an online service, such as, a music/media item sales or sharing website, a social networking website, or the like.

The media item virus module 100 may be configured to provide an interface to the information flow system of FIG. 1, and allow for identification of similarity data between media items. Through the media item virus module 100, a user may access playlist data 110.

Playlists identified in playlist data 110 may be associated with owners of the playlists. An owner of a playlist may be an individual that generated and/or regularly maintains the playlist. Playlists may also created by professional editors of the service, or playlists may be generated automatically, e.g., by similarity recommendation methods. The recommendation method may be any known recommendation method, such as collaborative filtering or content based, taking into account, for example, musical aspects such as rhythm, timbre, harmony, key, mood, theme, and so on. These playlists may be made available for download, and upon downloading a playlist generated by another, the individual downloading the playlist may become an owner of the playlist. Through interaction with the playlist data 110 via the media item virus module 100, a non-owner, also termed an “infector” herein, of a playlist may introduce a target media item, or virus media item, into a playlist.

In some embodiments, the infector may be an individual that has gained access to an owner's playlist and introduced a target media item. Alternatively, in some exemplary embodiments, the infector may be an algorithm. In this regard, the algorithm may be software agent that employs a recommendation engine to introduce target media items into the playlists of owners. The algorithm may identify target media items based on the similarity values between the original media items in the playlist and candidate media items. For example, if a candidate media item has a relatively high similarity value with many of the original playlist media items, then the candidate media item may be identified as a target media item and introduced to a playlist by the algorithm. In various exemplary embodiments of the present invention the algorithm may be implemented by the media item virus module 100 and/or a service 200 as further described below.

Based on a response by the owner of the playlist that now includes the target media item (e.g., a modified playlist), media item virus module 100 may provide for modifying media item similarity data 120. In turn, recommendation engine 130 may be modified because recommendation engine 130 may be configured to provide media item recommendations based on the media item similarity data 120. In this regard, recommendation engine 130 may be configured to analyze the playlist data 110, or a media item provided by a user, and make recommendations of other media items that are similar to the media items in the playlist or similar to the provided media item. The recommended media item may be determined by the recommendation engine 130 by analyzing the playlist 110 with respect to the media item similarity data 120. In some exemplary embodiments, media item similarity data for a recommended media item may indicate a high level of similarity between the media item and the media items currently present in the playlist, via, for example, a high similarity value or a similarity value that exceeds a predefined threshold. As a result, a media item may be recommended to the owner of a playlist for purchase or acquisition to be included in the playlist. As an example, users may request songs similar to “Lick it up” by Kiss, and the recommendation engine may then search for music tracks that have a high similarity value, or search for music tracks, that exceed a threshold similarity value with respect to the particular track, and return the results. If some users have inserted “Lick it up” into playlists containing tracks by Twisted Sister and generated responses or feedback indicating that the tracks are similar, Twisted Sister tracks may be returned as similar songs for “Lick it up.”

As users continue to introduce target media items to playlists, the system may accumulate additional media item similarity data. Based on the similarity data, the recommendation engine 130 may come to make improved media item similarity recommendations to users.

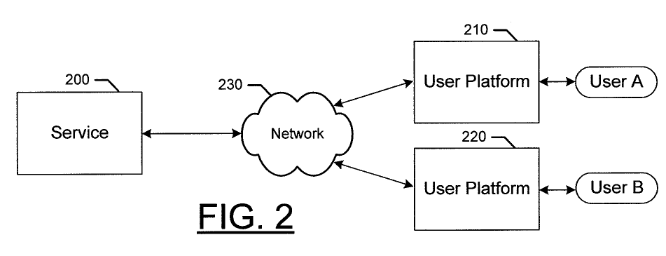

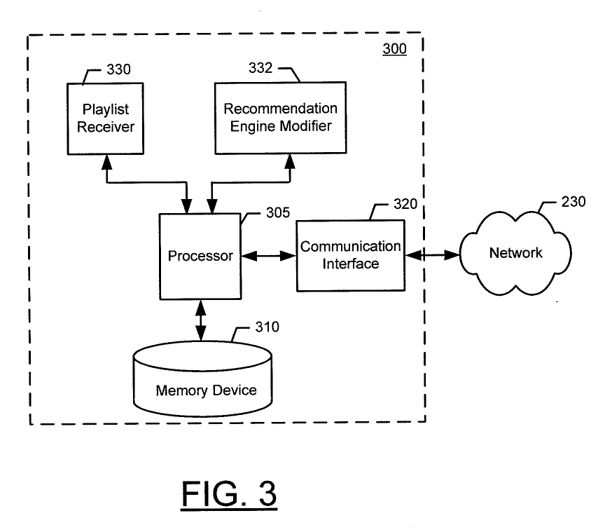

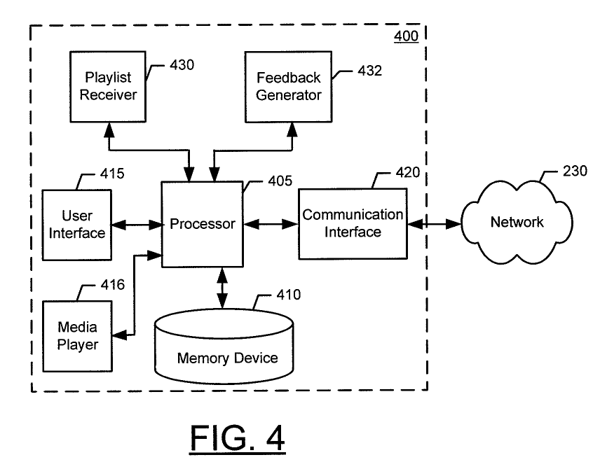

FIG. 2 illustrates a communications system including associated network entities that may interact to perform operations for identifying media item similarity data in accordance with various exemplary embodiments of the present invention. The communications system includes a service 200, user platforms 210 and 220, and a network 230. FIG. 3 illustrates a more detailed depiction of an example embodiment of the service 200, and FIG. 4 illustrates a more detailed depiction of an example embodiment of the user platforms 210 and 220. The network 230 may be any type of wired and/or wireless communications network.

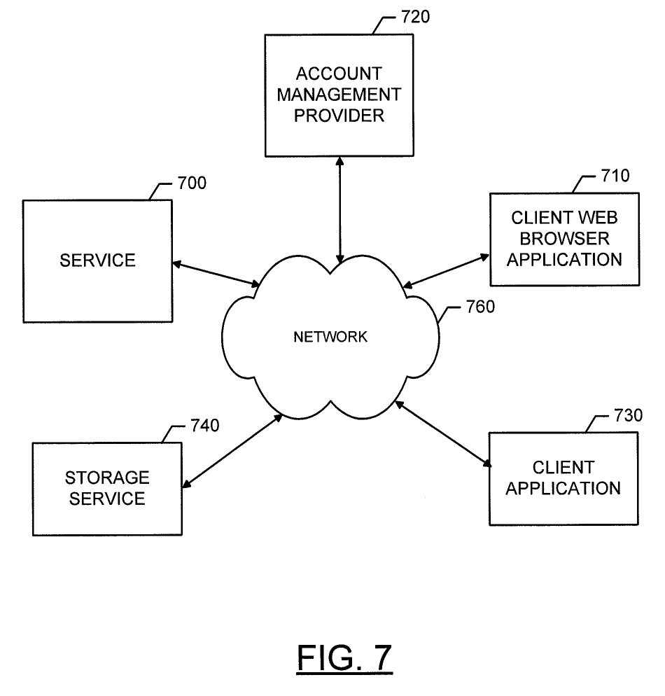

Referring now to FIG. 7, another embodiment of a system in accordance with an example embodiment of the present invention is illustrated. The system of FIG. 7 may include a service 700, a client web browser application 710, an account management provider 720, a client application 730, and a storage service 740. The service 700, the client web browser application 710, the account management provider 720, the client application 730, and the storage service 740 may be interconnected via the illustrated network 760. Furthermore, each of the service 700, the client web browser application 710, the account management provider 720, the client application 730, and the storage service 740 may be any device or means embodied in hardware, software or a combination of hardware and software configured for the performance of the corresponding functions of the service 700, the client web browser application 710, the account management provider 720, the client application 730, and the storage service 740, respectively, as described below.

In an example embodiment, the service 700, the account management provider 720, and the storage service 740, which may include memory, may collectively represent and/or employ an internet or network service (e.g., a website, a social networking website, a blog website, a web feed, a widget, a service platform, a server, and/or the like) that may receive and interact with communications to/from users via the client application 730 and/or the client web browser application 710. Various types of content, such as, but not limited to, music, audio, videos, pictures, other media items, maps, games, data files, books, text, journals, documents, messages, profile information, playlists, privacy options, television/radio programs or channels, internet sites or links, and/or the like, may be synchronized with and/or otherwise transferred to and from, the service 700. The service 700 may also enable users to transact business to acquire content via the service 700. In some cases the service 700 may enable users to utilize the storage service 740 for storage and retrieval of content by the service 700.

The account management provider 720 may operate together with the various other network entities to perform account management and security features. In some embodiments, login information and passwords are first directed to the account management provider 720 for verification. Upon verification, the account management provider 720 may provide access to, and allow communications between, various network entities using, for example, a token or other access key.

Client application 730 may be an application residing and operating on a platform (e.g., a user platform, such as user platforms 210 and/or 220), such as a computer, mobile terminal, and/or the like, that may be used to interact with the service 700. The client application 730 may be downloaded to and/or installed on the platform. In some embodiments, the client application 730 may be specifically tailored to interact with the service 700, that is, the client application 730 may be a dedicated application. Via the client application 730, the platform, and the user of the platform, may interact with the service 700 to send, receive, and/or modify, as well as synchronize, content between the client application 730 and the service 700. The client application 730 may facilitate the gathering and storage of content for subsequent transmission to the service 700.

Similar to the client application 730, the client web browser application 710 may be an application residing and operating on a platform (e.g., a user platform, such as user platforms 210 and/or 220), such as a computer, mobile terminal, and/or the like, that may be used to interact with the service 700. In this regard, the client web browser application 710 may be a generic network communication application for interacting with various network entities, including the service 700. Via the client web browser application 710, a platform, and the user of the platform, may interact with the service 700 to send, receive, and/or modify, as well as synchronize, data between the client web browser application 710 and the service 700. The client web browser application 710 may facilitate the gathering and storage of selections of privacy options and other data for subsequent transmission to the service 700.

In an example embodiment, the service 700 may provide users accessing the service 700 via the client application 730 or the client web browser application 710 with access to various content items, including, for example, playlists of other users. In this regard, the client application 730 and the web browser application 710 may be configured to facilitate the introduction of target media items into a playlist as described herein. In some situations, a user may search for or otherwise access specific content desired by the user. In other situations, the user may receive content from other users or even network entities on a solicited or unsolicited basis.

According to some embodiments of the present invention, the service 700 (or the device of the user (e.g., via the client web browser application 710 or the client application 730)) may provide for receiving a modified playlist from, for example, the client web browser application 710 or the client application 730. The modified playlist may include representations of original playlist media items and a representation of a target media item. The modification to the playlist may have been the introduction of the representation of a target media item to the playlist. Further, the system 700 may be configured to modify a recommendation engine based on feedback generated in response to the target media item having been played as part of the modified playlist via, for example, the client web browser application 710 or the client application 730.

FIG. 3 illustrates an exemplary service 200 that may provide for identifying media item similarities. According to various exemplary embodiments of the present invention, the service 200 may be embodied as, or included as a component of, a computing device such as any type of wired or wireless communications device, such as, for example, a mobile terminal such as, a mobile telephone, a portable digital assistant (PDA), a pager, a mobile television, a gaming device, a mobile computer, a laptop computer, a camera, a video recorder, an audio/video player, a radio, and/or a global positioning system (GPS) device, a network entity such as an access point such as a base station, or any combination of the aforementioned, or the like. Further, the service 200 may be configured to implement various aspects of the present invention as described herein including, for example, various exemplary methods of the present invention, where the methods may be implemented by means of a hardware or software configured processor, computer-readable medium, or the like.

The service 200 may include or otherwise be in communication with a processor 305, a memory device 310, and a communication interface 320. In some embodiments, the service 200 may also include a user interface. The processor 305 may be embodied as various means including, for example, a microprocessor, a coprocessor, a controller, or various other processing devices including integrated circuits such as, for example, an ASIC (application specific integrated circuit), an FPGA (field programmable gate array), or a hardware accelerator. In an exemplary embodiment, the processor 305 may be configured to execute instructions stored in the memory device 310 or instructions otherwise accessible to the processor 305. Processor 305 may also be configured to facilitate communications via the communications interface 320 by, for example, controlling hardware and/or software included in the communications interface 320.

The memory device 310 may be a computer-readable storage medium that may include volatile and/or non-volatile memory. For example, memory device 310 may include Random Access Memory (RAM) including dynamic and/or static RAM, on-chip or off-chip cache memory, and/or the like. Further, memory device 310 may include non-volatile memory, which may be embedded and/or removable, and may include, for example, read-only memory, flash memory, magnetic storage devices (e.g., hard disks, floppy disk drives, magnetic tape, etc.), optical disc drives and/or media, non-volatile random access memory (NVRAM), and/or the like. Memory device 310 may include a cache area for temporary storage of data. In this regard, some or all of memory device 310 may be included within the processor 305.

Further, the memory device 310 may be configured to store information, data, applications, computer-readable program code instructions, or the like for enabling the processor 305 and the apparatus 300 to carry out various functions in accordance with exemplary embodiments of the present invention. For example, the memory device 310 could be configured to buffer input data for processing by the processor 305. Additionally, or alternatively, the memory device 310 may be configured to store instructions for execution by the processor 305.

The communication interface 320 may be any device or means embodied in either hardware, software, or a combination of hardware and software that is configured to receive and/or transmit data from/to a network and/or any other device or module in communication with the apparatus 300. In this regard, the communication interface 320 may include, for example, an antenna, a transmitter, a receiver, a transceiver and/or supporting hardware, including a processor or software for enabling communications with network 230. Via the communication interface 320 and the network 230, the service 200 may communicate with various other network entities.

The communications interface 320 may be configured to provide for communications in accordance with any wired or wireless communication standard. For example, communications interface 320 may be configured to provide for communications in accordance with second-generation (2G) wireless communication protocols IS-136 (time division multiple access (TDMA)), GSM (global system for mobile communication), IS-95 (code division multiple access (CDMA)), third-generation (3G) wireless communication protocols, such as Universal Mobile Telecommunications System (UMTS), CDMA2000, wideband CDMA (WCDMA) and time division-synchronous CDMA (TD-SCDMA), 3.9 generation (3.9G) wireless communication protocols, such as Evolved Universal Terrestrial Radio Access Network (E-UTRAN), with fourth-generation (4G) wireless communication protocols, international mobile telecommunications advanced (IMT-Advanced) protocols, Long Term Evolution (LTE) protocols including LTE-advanced, or the like. Further, communications interface 320 may be configured to provide for communications in accordance with techniques such as, for example, radio frequency (RF), infrared (IrDA) or any of a number of different wireless networking techniques, including WLAN techniques such as IEEE 802.11 (e.g., 802.11a, 802.11b, 802.11g, 802.11n, etc.), wireless local area network (WLAN) protocols, world interoperability for microwave access (WiMAX) techniques such as IEEE 802.16, and/or wireless Personal Area Network (WPAN) techniques such as IEEE 802.15, BlueTooth (BT), ultra wideband (UWB) and/or the like.

Playlist manager 330 and recommendation engine modifier 332 of service 200 may be any means or device embodied in hardware, software, or a combination of hardware and software, such as processor 305 implementing software instructions or a hardware configured processor 305, that is configured to carry out the functions of playlist manager 330 and/or recommendation engine modifier 332 as described herein. In an exemplary embodiment, the processor 305 may include, or otherwise control the playlist manager 330 and/or recommendation engine modifier 332. In various exemplary embodiments, playlist manager 330 and/or recommendation engine modifier 332 may reside on differing apparatuses such that some or all of the functionality of the playlist manager 330 and/or recommendation engine modifier 332 may be performed by a first apparatus, and the remainder of the functionality of the playlist manager 330 and/or recommendation engine modifier 332 may be performed by one or more other apparatuses.

The playlist manager 330 may be configured to receive a modified playlist. In this regard, the playlist manager 330 may be configured to receive a modified playlist that includes representations of original playlist media items and a representation of a target media item. The modification to the playlist may have come as a result of the introduction of the representation of the target media item into the playlist.

In this regard, in some exemplary embodiments, the playlist manager 330 may be generally configured to provide for interactions between user platforms and playlists in accordance with various embodiments of the present invention. The playlist manager 330 may be configured to have access to playlists. In this regard, an owner's new or modified playlists may be uploaded to, for example, the memory device 310, or other data storage device accessible to playlist manager 330, from a user platform, such as user platforms 210 and 220. The playlists may be stored by the playlist manager 330 such that the playlist manager 330 may maintain access to the uploaded playlists. In some exemplary embodiments of the present invention, owners of playlists may generate and/or modify playlists through the playlist manager 330, and the playlist manager 330 may be configured to push the newly generated or modified playlists to the owner's user platform. In some exemplary embodiments, the playlist manager 330 may be configured to allow for select playlists to be protected such that an infector may not be able to modify the protected playlists.

The playlist manager 330 may also be configured to allow an infector to access a playlist and introduce a target media item into the playlist. In this regard, the playlist manager 330 may make playlists belonging to owners that have subscribed to a media item virus service available for viewing and/or interaction by potential infectors. The playlist manager 330 may be further configured to modify a playlist selected by an infector to introduce a target media item selected by the infector. In this regard, the playlist manager may be configured to receive the modified playlist. The playlist manager 330 may also provide for pushing the modified playlist to the playlist owner's user platform in response to modifications to the playlist.

In some exemplary embodiments, the playlist manager 330 may also be configured to make the target media item accessible to the playlist owner's user platform. In this regard, the target media item may be downloaded to the owner's user platform with or without a restricted license, or streamed to the owner's user platform in response to an attempt to play the target media item. In some embodiments, the target media item may already reside in the memory of the owner's user platform, and the playlist manager 330 may permit access to the target media content item via the modified playlist by, for example, providing an access key to the media content item or otherwise linking to the target media item via the playlist.

The recommendation engine modifier 332 may be configured to modify a recommendation engine (e.g., recommendation engine 130) based on feedback generated in response to the target media item having been played as part of a modified playlist. In this regard, the recommendation engine modifier 332 may receive feedback from, for example, an owner's user platform in response to the owner having played at least a portion of the target media item within the playlist. In some exemplary embodiments, the recommendation engine may be modified by modifying similarity data or other data stored within a computer-readable storage medium, such as memory device 310.

In some exemplary embodiments, feedback may be received in the form of a feedback message. The feedback message may indicate that the target media item is similar to the original playlist media items, or the feedback message may indicate that the target media item is dissimilar to the original playlist media items. In various exemplary embodiments, the activities of the owner with respect to the target media item and the owner's user platform may be analyzed to determine whether similar or dissimilar feedback messages may be received.

In this regard, an owner of a modified playlist may play the playlist and recognize that the target media item does not belong in the playlist. In response, the owner may cause feedback, such as in the form of a feedback message a feedback message to be sent, and in turn, received by the recommendation engine modifier 332. The feedback may indicate that the target media item is dissimilar from the original playlist media items. In some exemplary embodiments, a feedback message indicating a dissimilar target media item may be received in response to an owner having played a modified playlist and skipped to the next media item in the playlist before the target media item was completely played or in response the owner having otherwise stopped playback of the target media item before playback was complete. In this regard, it may be inferred that the owner skipped to the next media item or stopped playback because the owner found the target media item to be dissimilar. In some exemplary embodiments, in response to feedback indicating that the target media item is dissimilar from the original playlist media items, the recommendation engine modifier 332 may be configured to request that the playlist manager 330 remove the target media item from the playlist.

On the other hand, the owner of a playlist may play the playlist and not recognize the addition of the target media item, due to the target media item's similarity with the original playlist media items. In some exemplary embodiments, a feedback message may be received indicating that the target media item is similar if all or substantially all of the media item was played or if a threshold period of time has elapsed since the target media item was played and no feedback message indicating that the target media item is dissimilar was generated by the owner.

Further, the recommendation engine modifier 332 may be configured to modify a recommendation engine in response to the feedback. The recommendation engine may be an entity that is configured to analyze playlists to recommend similar media items to those already present in the playlist or otherwise make similarity recommendations. The recommendation engine may recommend the similar media items for download or purchase.

The recommendation engine modifier 332 may be configured to modify the recommendation engine by modifying a similarity value associated with a target media item. The similarity value may describe a relationship between the target media item and each original playlist media item. In this regard, a similarity value may be a floating point value between zero and one, where a similarity value of one would indicate that two media items are exactly the same, a similarity value of zero would indicate that two media items are completely dissimilar and a similarity value of between one and zero would be proportionally related to the similarity between two media items. According to various exemplary embodiments, many different similarity representations may be possible, such as integer values between 1 and 255 with 1 denoting minimum similarity and 255 denoting maximum similarity. Similarity values may be predefined, may be defined by user input, may be defined based upon various criteria including similarities in artist, genre, time period or the like, or other techniques for gauging similarity. Examples of such techniques may include well-known collaborative filtering based recommendation methods or content based recommendation methods taking into account content properties such as, for music, the music's genre, mood, style, year, tempo, key, or harmony. Feedback indicating that the target media item is similar to the original playlist media items may result in recommendation engine modifier 332 increasing the similarity value. Feedback indicating that the target media item is dissimilar to the original playlist media items may result in recommendation engine modifier 332 decreasing the similarity value. The similarity values may be stored in a local or remote database for use by the recommendation engine. In some exemplary embodiments, recommendation engine modifier 332 may additionally or alternatively be configured to modify the recommendation engine by storing a new playlist that includes the original playlist media items and the target media item if a similar feedback message is received. In some exemplary embodiments, the target media item may be added to several playlists, for example, those playlists that have some common songs, such as the songs that precede the target media item. The newly stored playlist may be later utilized by the recommendation engine to recommend entire playlists or media items included in similar playlists.

The recommendation engine modifier 332 may also be configured to modify a user score associated with the infector based on the feedback. In this regard, the introduction of a target media item in a playlist may be correlated to a game. An infector that is successful in finding similarities amongst media items may be rewarded with an increased user score. On the other hand, an infector that introduces a dissimilar target media item into a playlist may be penalized with a decreased user score.

With respect to scoring, if the owner of the playlist likes the introduction of the target media item to the playlist, the owner may become an infector and introduce the target media item into other playlists. This successive introduction of a target media item by an owner to other playlists may result in an epidemic with respect to the target media item. In various exemplary embodiments, recommendation engine modifier 332 may be configured to track the successive introductions of the target media item to playlists and reward the original infector each time the target media item is introduced to a new playlist and/or each time an owner of a modified playlist provides similar feedback for the target media item.

In some exemplary embodiments, the amount of increase/decrease in the infector's user score may be calculated automatically by the recommendation engine modifier 332. In this regard, the recommendation engine modifier 332 may be configured to check the current similarity value of the target media item to the playlist, calculate a change in the in the user score, and report the change and/or score to the user platform of the infector.

Generally, infecting playlists may be much easier if an infector has a broad media content taste and/or has knowledge of various genres. Therefore, the infector could be additionally rewarded if the infector is able to infect the playlist of an owner with limited or less broad media content taste (e.g., a person listening to only a couple of music artists). Another reason for providing an additional reward may be that if a person with limited musical taste starts listening to more diverse music, a music service may earn more profit in the future.

If the infector adds a target media item to a playlist describing an album or other generally recognized collection of media items, and the owner provided feedback indicating that the target media item is similar, the infector may be increasingly rewarded with a higher user score. Further, adding less known or less popular media items, and thus potentially increasing sales, may increasingly reward an infector more than adding, for example, the most popular songs currently on the hit list.

Further, if the recommendation engine modifier 332 determines that a target media item is a rather weak match to the playlist, but similar feedback is still received, the media item may actually be a good recommendation and the infector may be rewarded with an increased user score. Correspondingly, if the media item is rated very similar by the recommendation engine modifier 332, the increase in the user score may be smaller.

Further, in some exemplary embodiments the recommendation engine modifier 332 may provide for posting top lists of the most successful infectors (e.g. “Top 100 infectors” or “Worst musical epidemics in the world”). As a result, other users may see an infector's high user score or how much virtual money the infector has earned, and the other users become more interested in infecting their friends' playlists as well.

If an owner has generated the playlist manually, most or all of the media items may be from the owner's collection. Further, the media items may be of various styles (e.g. “Most played” playlist) and thus may not be similar to each other in a general sense. However, one way to increase the sales could be to allow the infector to add target media items from an online media item sales service to an owner's manually generated playlists. For example, the media items may be streamed, or otherwise be made accessible to owner's user platform so the owner does not own full rights to the target media items. If the owner provides for feedback indicating that the target media item is similar, the recommendation engine modifier 332 may be configured to ask whether the owner desires to buy full rights to the target media item. If the owner buys the target media item, the infector may be increasingly rewarded with a higher user score. In this regard, the more the target media unit differs from the original playlist media items, the more the infector may be rewarded. However, the infector should be careful because the recommendation engine modifier 332 may also be configured to penalize the infector for adding target media items that the owner does not recognize as being similar.

In an additional exemplary embodiment, the infector may be a computer algorithm. For example, the service may incorporate different recommendation methods or software agents to act as infectors and may configure the infectors to insert media items into existing playlists or modify the similarity data created using some other method. In this regard, an algorithm, acting as an infector, may receive as an input the existing playlist or similarity values of the original playlist media items, and the algorithm's logic may be configured to insert target media items into the playlist that are similar to the original playlist media items. Using automatic infectors may allow the service to collect more feedback on song similarities, introduce more variation and interestingness to the playlists, and benchmark potential novel recommendation methods whose performance is not yet fully known and understood. For example, when a new recommendation method is enabled to act as an infector, and it is determined that most of the target media items The recommendation method inserts are left unnoticed, lead to customer transactions (buying the song) and/or receive good feedback from the users the service may determine that the new recommendation method has a good performance and should perhaps be taken into use in the service. The infector may also be a professional individual employed by the service or a record label, whose job is to try to introduce more music to the user's lists by using his musical expertise to find related music to existing playlists and make the insertions. The performance of the professional may also be tested in the manner described above.

As depicted in FIG. 2, the service 200 may communicate with the user platforms 210 and 220 via the network 230. An exemplary conceptual architecture of user platform 210 and 220 may be described by referring to FIG. 4. FIG. 4 illustrates an exemplary user platform 210, 220 that may provide for identifying media item similarities. According to various exemplary embodiments of the present invention, the user platform may be embodied as, or included as a component of, a computing device including, but not limited to, a personal computer, a workstation or any type of wired or wireless communications device, such as, for example, a mobile terminal such as, a mobile telephone, a portable digital assistant (PDA), a pager, a mobile television, a gaming device, a mobile computer, a laptop computer, a camera, a video recorder, an audio/video player, a radio, and/or a global positioning system (GPS) device, or the like. Further, the user platform may be configured to implement various aspects of the present invention as described herein including, for example, various exemplary methods of the present invention, where the methods may be implemented by means of a hardware or software configured processor, computer-readable medium, or the like.

The user platform may include or otherwise be in communication with a processor 405, a memory device 410, a communication interface 420, a user interface 415, and a media player 416. The processor 405 may be embodied as various means including, for example, a microprocessor, a coprocessor, a controller, or various other processing devices including integrated circuits such as, for example, an ASIC (application specific integrated circuit), an FPGA (field programmable gate array), or a hardware accelerator. In an exemplary embodiment, the processor 405 may be configured to execute instructions stored in the memory device 410 or instructions otherwise accessible to the processor 405. Processor 405 may also be configured to facilitate communications via the communications interface 420 by, for example, controlling hardware and/or software included in the communications interface 420.

The memory device 410 may be a computer-readable storage medium that may include volatile and/or non-volatile memory. For example, memory device 410 may include Random Access Memory (RAM) including dynamic and/or static RAM, on-chip or off-chip cache memory, and/or the like. Further, memory device 410 may include non-volatile memory, which may be embedded and/or removable, and may include, for example, read-only memory, flash memory, magnetic storage devices (e.g., hard disks, floppy disk drives, magnetic tape, etc.), optical disc drives and/or media, non-volatile random access memory (NVRAM), and/or the like. Memory device 410 may include a cache area for temporary storage of data. In this regard, some or all of memory device 410 may be included within the processor 405.

Further, the memory device 410 may be configured to store information, data, applications, computer-readable program code instructions, or the like for enabling the processor 405 and the user platform to carry out various functions in accordance with exemplary embodiments of the present invention. For example, the memory device 410 could be configured to buffer input data for processing by the processor 405. Additionally, or alternatively, the memory device 410 may be configured to store instructions for execution by the processor 405.

The communication interface 420 may be any device or means embodied in either hardware, software, or a combination of hardware and software that is configured to receive and/or transmit data from/to a network and/or any other device or module in communication with the user platform. In this regard, the communication interface 420 may include, for example, an antenna, a transmitter, a receiver, a transceiver and/or supporting hardware, including a processor or software for enabling communications with network 230. Via the communication interface 420 and the network 230, the user platform may communicate with various other network entities.

The communications interface 420 may be configured to provide for communications in accordance with any wired or wireless communication standard. For example, communications interface 420 may be configured to provide for communications in accordance with second-generation (2G) wireless communication protocols IS-136 (time division multiple access (TDMA)), GSM (global system for mobile communication), IS-95 (code division multiple access (CDMA)), third-generation (3G) wireless communication protocols, such as Universal Mobile Telecommunications System (UMTS), CDMA2000, wideband CDMA (WCDMA) and time division-synchronous CDMA (TD-SCDMA), 3.9 generation (3.9G) wireless communication protocols, such as Evolved Universal Terrestrial Radio Access Network (E-UTRAN), with fourth-generation (4G) wireless communication protocols, international mobile telecommunications advanced (IMT-Advanced) protocols, Long Term Evolution (LTE) protocols including LTE-advanced, or the like. Further, communications interface 420 may be configured to provide for communications in accordance with techniques such as, for example, radio frequency (RF), infrared (IrDA) or any of a number of different wireless networking techniques, including WLAN techniques such as IEEE 802.11 (e.g., 802.11a, 802.11b, 802.11g, 802.11n, etc.), wireless local area network (WLAN) protocols, world interoperability for microwave access (WiMAX) techniques such as IEEE 802.16, and/or wireless Personal Area Network (WPAN) techniques such as IEEE 802.15, BlueTooth (BT), ultra wideband (UWB) and/or the like.

The user interface 415 may be in communication with the processor 405 to receive user input at the user interface 415 and/or to provide output to a user as, for example, audible, visual, mechanical or other output indications. The user interface 415 may include, for example, a keyboard, a mouse, a joystick, a display (e.g., a touch screen display), a microphone, a speaker, or other input/output mechanisms. In some exemplary embodiments, the user interface 415 may be limited, or even eliminated.

The media player 416 may be configured to facilitate playing media items on the user platform. In an exemplary embodiment, the processor 405 may include, or otherwise control the media player 416. The media player 416 may be configured to receive a media item, such as in the form of a data file, from memory device 410, the service 200, or another user platform, and play the media item. In some exemplary embodiments, media player 416 may be configured to receive a media item as a data stream from, for example the service 200 or another user terminal, and play the media item. The media item may be played by controlling the user interface 415 to allow a user to experience the media item. For example, the media player 416 may be configured to receive a music track, and play the music track through speakers included in the user interface 415. The media player 416 may also be configured to receive a playlist, and play media items in accordance with the playlist.

Playlist receiver 430 and feedback generator 432 of user platform 210, 220 may be any means or device embodied in hardware, software, or a combination of hardware and software, such as processor 405 implementing software instructions or a hardware configured processor 405, that is configured to carry out the functions of playlist receiver 430 and/or feedback generator 432 as described herein. In an exemplary embodiment, the processor 405 may include, or otherwise control the playlist receiver 430 and/or feedback generator 432. In various exemplary embodiments, the playlist receiver 430 and/or feedback generator 432 may reside on differing apparatuses such that some or all of the functionality of the playlist receiver 430 and/or feedback generator 432 may be performed by a first apparatus, and the remainder of the functionality of the playlist receiver 430 and/or feedback generator 432 may be performed by one or more other apparatuses.

The playlist receiver 430 may be configured to receive a modified playlist. The modified playlist may include representations of original playlist media items and a representation of a target media item. The modification to the playlist may have been the introduction of the target media item to the playlist.

According to various exemplary embodiments, the playlist receiver 430 may receive the modified playlist from the service 200. Alternatively, in some exemplary embodiments, modifications to playlists may be conducted in a peer-to-peer fashion. In this regard, a user platform may have an owner's playlists stored in, for example, the memory device 410 of the user platform. The playlist receiver 430 may be configured to provide a potential infector access to the owner's playlists stored on the user terminal of the owner. The playlist receiver 430 may also be configured to provide for playlist modification capabilities. As a result, the infector may introduce a target media item into a playlist stored on the owner's user platform.

Whether the modified playlist is received from the service 200 or from another user platform, the playlist receiver 430 may be configured to receive the modified playlist and store the modified playlist in, for example, the memory device 410. In some embodiments, the playlist receiver 430 may be configured to provide the playlist to the media player 416 and allow for playing the media items associated with the playlist.

The feedback generator 432 may be configured to modify a recommendation engine based on feedback generated in response to a target media item having been played as part of a modified playlist. In this regard, the feedback generator 432 may determine the similarity/dissimilarly of the target media item with respect to the original playlist media items and provide feedback in this regard to, for example, the service 200 to in turn modify the recommendation engine. In some exemplary embodiments, the feedback generator 432 may be configured to generate a feedback message and provide for transmitting the feedback message to the service 200 via the network 230.

Feedback generator 432 may be configured to receive input from a playlist owner regarding the similarity or dissimilarity of the target media item with respect to the original playlist media items. In this regard, the feedback generator 432 may be configured to include an option for allowing an owner to report the dissimilarity of the target media item, for example, by selecting an option on the user interface 415 of the user platform indicating that media item virus has been identified. Further, the feedback generator may be configured to monitor playback of the target media item, and if the owner stops playback before the entire target media item is played or the owner skips to the next media item in the playlist, a dissimilar target media item may be inferred and corresponding feedback may be generated.

Further, an owner may find that the target media item is similar or, due the target media item's similarity, the owner may not recognize that the target media item has been introduced to the playlist. In this regard, the feedback provider 432 may be configured to receive input from the owner indicating that the target media item is similar to the original playlist media items. The feedback generator may also be configured to monitor playback of the target media item, and if the owner completes playback of the entire target media item, a similar target media item may be inferred and corresponding feedback may be generated.

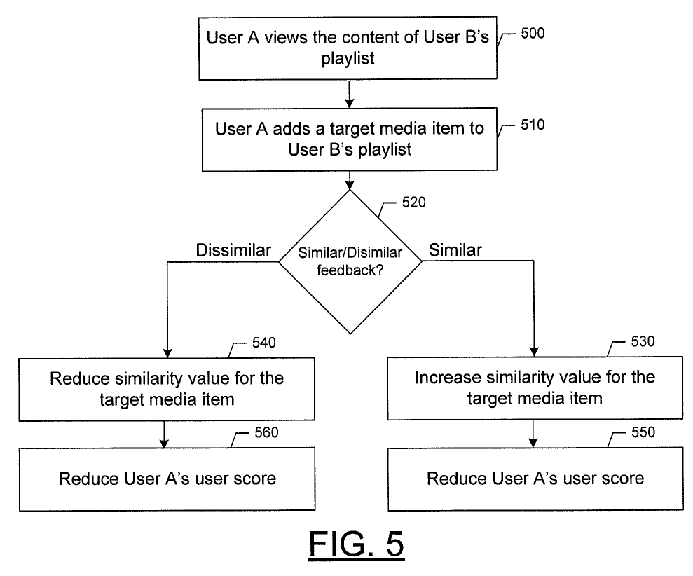

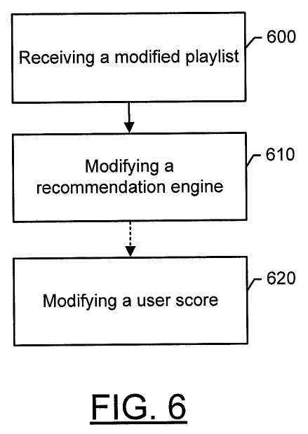

FIGS. 5 and 6 illustrate flowcharts of a system, method, and computer program product according to exemplary embodiments of the invention. It will be understood that each block, step, or operation of the flowcharts, and/or combinations of blocks, steps, or operations in the flowcharts, can be implemented by various means. Means for implementing the blocks, steps, or operations of the flowchart, and/or combinations of the blocks, steps or operations in the flowcharts may include hardware, firmware, and/or software including one or more computer program code instructions, program instructions, or executable computer-readable program code instructions. In one exemplary embodiment, one or more of the procedures described herein may be embodied by program code instructions. In this regard, the program code instructions which embody the procedures described herein may be stored by or on a memory device, such as memory device 310 or 410, of an apparatus, such as service 200 or user platforms 210 or 220, and executed by a processor, such as the processor 305 or 405. As will be appreciated, any such program code instructions may be loaded onto a computer or other programmable apparatus (e.g., processor 305 or 405, memory device 310 or 410) to produce a machine, such that the instructions which execute on the computer or other programmable apparatus create means for implementing the functions specified in the flowcharts' block(s), step(s), or operation(s). These program code instructions may also be stored in a computer-readable storage medium that can direct a computer, a processor, or other programmable apparatus to function in a particular manner, such that the instructions stored in the computer-readable storage medium produce an article of manufacture including instruction means which implement the function specified in the flowchart's block(s), step(s), or operation(s). The program code instructions may also be loaded onto a computer, processor, or other programmable apparatus to cause a series of operational steps to be performed on or by the computer, processor, or other programmable apparatus to produce a computer-implemented process such that the instructions which execute on the computer, processor, or other programmable apparatus provide steps for implementing the functions specified in the flowcharts' block(s), step(s), or operation(s).

Accordingly, blocks, steps, or operations of the flowcharts support combinations of means for performing the specified functions, combinations of steps for performing the specified functions, and program code instruction means for performing the specified functions. It will also be understood that one or more blocks, steps, or operations of the flowcharts, and combinations of blocks, steps, or operations in the flowcharts, can be implemented by special purpose hardware-based computer systems which perform the specified functions or steps, or combinations of special purpose hardware and program code instructions.

FIG. 5 depicts a flowchart describing an exemplary method of the present invention. The exemplary method of FIG. 5 is described with respect to example users, namely, User A, who assumes the role of an infector, and User B, who assumes the role of an owner. The exemplary method may be described with reference to the communications system of FIG. 2.

At 500, User A views the content of User B's playlist. In this regard, User A may utilize user platform 210 to view User B's playlist by accessing User B's playlist at the service 200, or at User B's user platform 220. At 510, User A adds a target media item to User B's playlist.

At 520, User B's user platform 220 may generate similar feedback or dissimilar feedback based on the actions of User B as described above. If User B's actions with regard to the target media item indicate that the target media item is dissimilar from the original playlist media items, in some exemplary embodiments, a similarity value for the target media item may be reduced at 540. Further, in some exemplary embodiments, at 560, User A's user score may be reduced because User A introduced a dissimilar target media item. On the other hand, if User B's action with regard to the target media item indicates that the target media item is similar to the original playlist media items, in some exemplary embodiments, a similarity value for the target media item may be increased at 530. Further, in some exemplary embodiments, at 550, User A's user score may be increased because User A introduced a similar target media item.

FIG. 4 illustrates a flowchart describing an exemplary method of the present invention for identifying media item similarities. At 600, the method includes receiving a modified playlist. In this regard, the modified playlist may include representations of original playlist media items and a representation of a target media item. The modification to the playlist may have occurred as a result of the introduction of the representation of a target media item to the playlist. Further, in some exemplary embodiments, receiving the modified playlist may include the modification to the playlist being the introduction of the representation of the target media item by a user or infector.

The exemplary method of FIG. 6 may also include modifying a recommendation engine based on feedback generated in response to the target media item having been played as part of the modified playlist on a media player at 610. In some exemplary embodiments, modifying the recommendation engine may include modifying a similarity value associated with the target media item. In this regard, the similarity value may describe a relationship between the target media item and each of the original playlist media items. Further, in some exemplary embodiments, modifying the recommendation engine may include modifying the recommendation engine by storing a new playlist that includes the target media item and the original playlist media items. In some exemplary embodiments, the feedback may be a feedback message indicating that the target media item is similar to the original playlist media items or indicating that the target media item is dissimilar to the original playlist media items. The feedback message may be an indication of when a user or owner stopped playback of the target media item. Modifying the recommendation engine may also include providing for transmission of the feedback to a service, such as the service 200. Further, in some exemplary embodiments, the exemplary method of FIG. 6 may also include modifying a user score associated with a user based on the feedback at 620.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions other than those explicitly described above are also contemplated as may be set forth in some of the appended claims. Although specific terms are employed herein, they are used in a generic and descriptive sense only and not for purposes of limitation.

What is claimed is:

1. A method comprising:
receiving a modified playlist, the modified playlist including representations of original playlist media items and a representation of a target media item, the modification to the playlist having been an introduction of the representation of the target media item to the playlist; and
modifying a recommendation engine based on feedback generated in response to the target media item having been played as part of the modified playlist.

2. The method of claim 1, wherein receiving the modified playlist includes the modification to the playlist having been the introduction of the representation of the target media item by a user; and wherein the method further comprises modifying a user score associated with the user based on the feedback.

3. The method of claim 1, wherein modifying the recommendation engine includes modifying a similarity value associated with the target media item, the similarity value describing a relationship between the target media item and the original playlist media items.

4. The method of claim 1, wherein modifying the recommendation engine includes modifying the recommendation engine by storing a new playlist that includes the target media item and the original playlist media items.

5. The method of claim 1, wherein modifying the recommendation engine based on the feedback includes the feedback being a feedback message indicating that the target media item is similar to the original playlist media items or indicating that the target media item is dissimilar to the original playlist media items.

6. The method of claim 5, wherein modifying the recommendation engine based on the feedback message includes the feedback message being an indication of when a user stopped playback of the target media item.

7. The method of claim 1, wherein modifying the recommendation engine includes providing for transmission of the feedback to a service.

8. An apparatus comprising a processor, the processor configured to:
receive a modified playlist, the modified playlist including representations of original playlist media items and a representation of a target media item, the modification to the playlist having been an introduction of the representation of the target media item to the playlist; and
modify a recommendation engine based on feedback generated in response to the target media item having been played as part of the modified playlist.

9. The apparatus of claim 8, wherein the processor configured to receive the modified playlist includes being configured to receive the modified playlist, the modification to the playlist having been the introduction of the representation of the target media item by a user; and wherein the processor is further configured to modify a user score associated with the user based on the feedback.

10. The apparatus of claim 8, wherein the processor configured to modify the recommendation engine includes being configured to modify a similarity value associated with the target media item, the similarity value describing a relationship between the target media item and the original playlist media items.

11. The apparatus of claim 8, wherein the processor configured to modify the recommendation engine includes being configured to modify the recommendation engine by storing a new playlist that includes the target media item and the original playlist media items.

12. The apparatus of claim 8, wherein the processor configured to modify the recommendation engine based on the feedback includes being configured to modify the recommendation engine based on the feedback, the feedback being a feedback message indicating that the target media item is similar to the original playlist media items or indicating that the target media item is dissimilar to the original playlist media items.

13. The apparatus of claim 12, wherein the processor configured to modify to the recommendation engine based on the feedback message includes being configured to modify the recommendation engine based on the feedback message, the feedback message being an indication of when a user stopped playback of the target media item.

14. The apparatus of claim 8, wherein the processor configured to modify the recommendation engine includes being configured to provide for transmission of the feedback to a service.

15. The apparatus claim 1 further comprising a computer-readable storage medium; and wherein the processor configured to modify the recommendation engine includes being configured to modify the recommendation engine by modifying data stored within the computer-readable storage medium.

16. A computer program product comprising at least one computer-readable storage medium having executable computer-readable program code instructions stored therein, the computer-readable program code instructions comprising:
first program code instructions configured to receive a modified playlist, the modified playlist including representations of original playlist media items and a representation of a target media item, the modification to the playlist having been an introduction of the representation of the target media item to the playlist; and
second program code instructions configured to modify a recommendation engine based on feedback generated in response to the target media item having been played as part of the modified playlist.

17. The computer program product of claim 16, wherein the first program code instructions configured to receive the modified playlist includes being configured to receive the modified playlist, the modification to the playlist having been the introduction of the representation of the target media item by a user; and wherein the computer-readable program code instructions further comprise third program code instructions configured to modify a user score associated with the user based on the feedback.

18. The computer program product of claim 16, wherein the second program code instructions configured to modify the recommendation engine includes being configured to modify a similarity value associated with the target media item, the similarity value describing a relationship between the target media item and the original playlist media items.

19. The computer program product of claim 16, wherein the second program code instructions configured to modify the recommendation engine includes being configured to modify the recommendation engine by storing a new playlist that includes the target media item and the original playlist media items.

20. The computer program product of claim 16, wherein the second program code instructions configured to modify the recommendation engine based on the feedback includes being configured to modify the recommendation engine based on the feedback, the feedback being a feedback message indicating that the target media item is similar to the original playlist media items or indicating that the target media item is dissimilar to the original playlist media items.

21. The computer program product of claim 20, wherein the second program code instructions configured to modify to the recommendation engine based on the feedback message includes being configured to modify the recommendation engine based on the feedback message, the feedback message being an indication of when a user stopped playback of the target media item.

22. The computer program product of claim 16, wherein the second program code instructions configured to modify the recommendation engine includes being configured to provide for transmission of the feedback to a service.

23. An apparatus comprising:
means for receiving a modified playlist, the modified playlist including representations of original playlist media items and a representation of a target media item, the modification to the playlist having been an introduction of the representation of the target media item to the playlist; and
means for modifying a recommendation engine based on feedback generated in response to the target media item having been played as part of the modified playlist.

24. The apparatus of claim 23, wherein means for receiving the modified playlist include means for receiving the modified playlist, the modification to the playlist having been the introduction of the representation of the target media item by a user; and wherein the apparatus further comprises means for modifying a user score associated with the user based on the feedback.
